(19) United States
(12) Patent Application Publication
(10) Pub. No.: US 2022/0264874 A1
(43) Pub. Date: Aug. 25, 2022

(54) Handle Sanitizer and Kit

(71) Applicant: Riki W. DIAWARA, Beaverton, OR (US)

(72) Inventor: Riki W. DIAWARA, Beaverton, OR (US)

(21) Appl. No.: 17/180,154

(22) Filed: Feb. 19, 2021

(51) Int. Cl. A01N 25/16; A01N 43/68; A01N 31/02; A01N 37/02; A01N 65/28; A01N 25/34; A01N 25/02

(52) U.S. Cl. CPC A01N 25/16; A01N 43/68; A01N 31/02; A01N 37/02; A01N 65/28; A01N 25/34; A01N 25/02

(57) ABSTRACT

Transmission of pathogens may be reduced by placing an absorbent cover over high-touch control surfaces such as door and drawer handles and toilet flush levers, and then soaking the absorbent cover with an antiseptic liquid such as an alcohol-based solution, a mild acid solution, or a solution containing other ingredients having antimicrobial and antiviral properties. The antiseptic liquid may be applied periodically by means of an atomizer or sprayer. Absorbent covers may be made of an open-cell foam, such as a melamine foam.

### CONTINUITY AND CLAIM OF PRIORITY

This is an original U.S. patent application.

### FIELD

The invention relates to surface sanitation and disinfection. More specifically, the invention relates to apparatus to impede contamination and transmission of infectious agents via high-touch surfaces.

### BACKGROUND

The worldwide pandemic of 2019 and subsequent years demonstrated the importance of public hygiene, disinfection and sanitation measures to the continued operation of societal and economic systems. And although that pandemic was eventually recognized as the result of a largely airborne pathogen, it became clear that other hygiene methods and assistive technologies also played a significant role in controlling the spread of infectious diseases.

There are, of course, a wide range of existing sanitation and disinfection technologies, materials and procedures, but defense in depth has been shown to produce improved outcomes. Thus, new apparatus and methods of fighting disease, whether on old or on new battlegrounds, are always in demand.

### SUMMARY

Embodiments of the invention are structures of absorbent media such as open-cell foam, configured to cover or affix to high-touch surfaces such as appliance controls and handles, which are soaked with a liquid disinfectant or antiseptic solution and are thus operative to damage or destroy pathogens that come in contact with the soaked absorbent media, resulting in a reduced risk of infection to a user interacting with the covered surface.

### BRIEF DESCRIPTION OF DRAWINGS

FIG. 1 shows a handle sanitizer according to an embodiment of the invention.

FIG. 2 shows another handle sanitizer according to an embodiment.

FIG. 3 shows an alternative handle sanitizer according to an embodiment.

FIG. 4 shows a fourth alternative handle sanitizer according to an embodiment of the invention.

FIG. 5 shows a manufacturing method for an embodiment.

FIG. 6 shows an alternate handle sanitizer form according to an embodiment of the invention.

FIG. 7 shows a kit of handle-sanitizing components that may be co-packaged and distributed together.

FIG. 8 shows how an embodiment of the invention may be installed on a lever or handle.

### DETAILED DESCRIPTION

Embodiments of the invention are flexible, absorbent covers for handles, appliance controls, and similar surfaces. These covers are adapted to be placed on or over a handle and then soaked with a liquid disinfectant. The disinfectant neutralizes infectious particles on the handle, and also reduces the chance that a user who touches the handle will be harmed by using the device. In addition, the disinfectant helps neutralize infectious particles between users—without the handle cover, a sick (and/or contagious) person who uses the handle may leave behind particles that could infect the next person. However, the disinfectant-soaked cover interferes with this transmission pathway, protecting the second user from the first. Handle covers are especially beneficial for applications such as toilet flush levers.

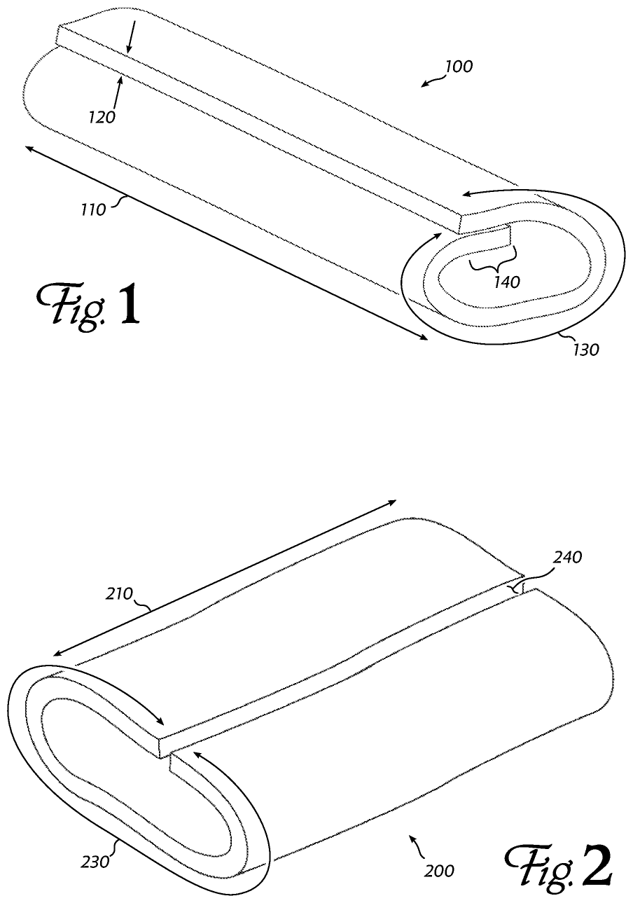

FIG. 1 shows a handle cover 100 according to an embodiment of the invention. The cover is a flexible, absorbent tubular structure of suitable length 110, having a thickness 120 and a circumference 130. This embodiment is made as a rolled or curled sheet, where opposite sides of the sheet are joined in an overlap joint indicated at 140. The length, thickness and circumference of an embodiment are chosen to suit the size of handle or lever they are intended to cover. Although this embodiment shows a simple tube, more-complex shapes may be constructed to fit snugly on other surfaces.

An embodiment may be soaked with a disinfectant or antiseptic solution before being placed over the lever, or the disinfectant solution may be coated or sprayed onto the absorbent material after installation. In addition, more disinfectant solution may be added to the absorbent material to replace any that has evaporated or been carried away by other processes. When the cover becomes soiled, it may be removed and discarded, and a new cover put in place.

FIG. 2 shows another handle cover 200 according to an embodiment. This version is similar to that shown in FIG. 1: a flexible, absorbent tubular structure having a length 210 and a circumference 230. In this embodiment, a butt joint 240 between side faces of a sheet of absorbent material is used in place of the overlap joint 140 of the previous item.

FIG. 3 shows an embodiment that is a pre-formed tube of absorbent, flexible material 300, having a length 310, thickness 320 and diameter 350. Embodiments of this form may be cut from a longer spool of tubular material.

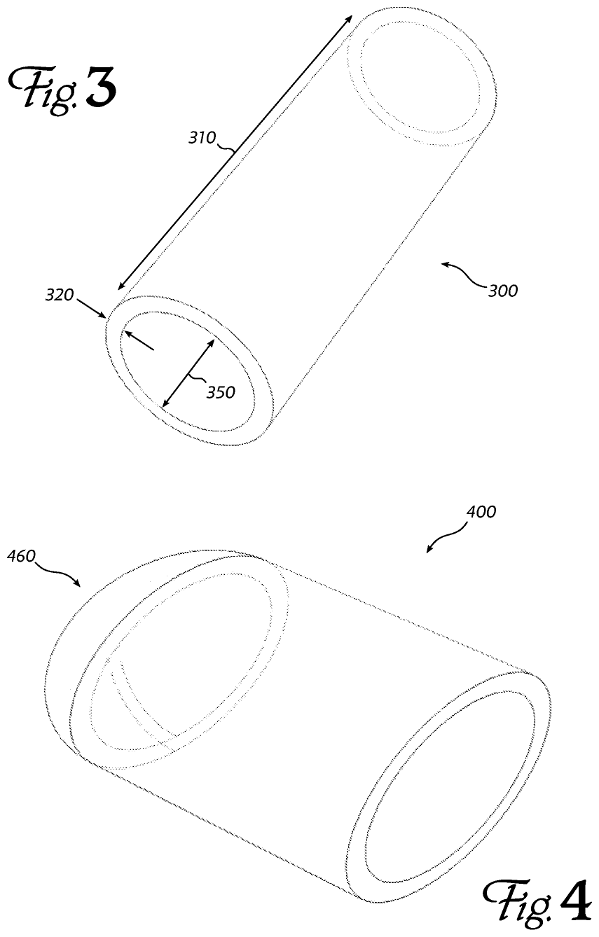

FIG. 4 shows another embodiment 400. This form may be cast with a suitable size, shape, and a cover over one end 460.

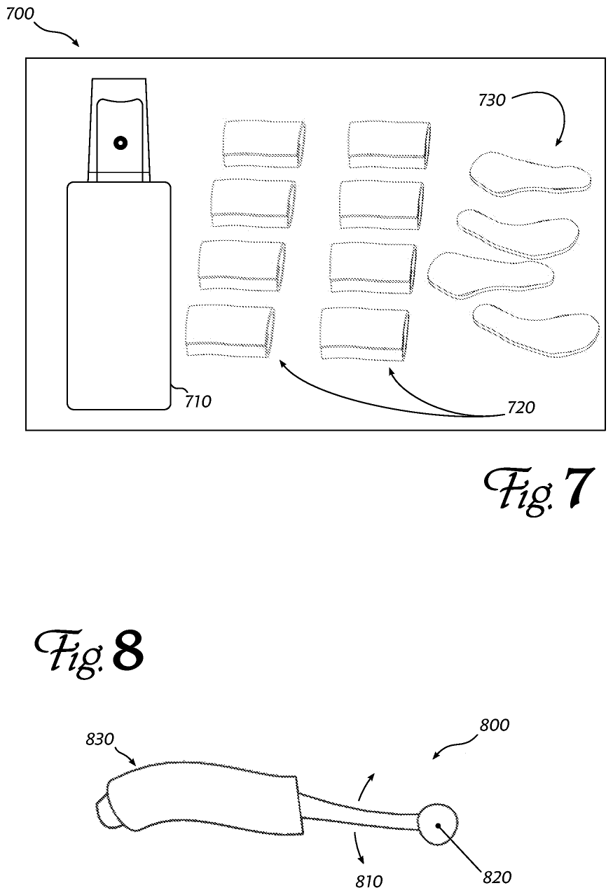

FIG. 8 shows how one of the foregoing tubular embodiments may be installed on a lever handle such as a door handle or a toilet flush lever. The lever 800 extends a suitable distance from a pivot point 820, and is operated by raising or lowering the handle, 810. An embodiment is soaked with disinfectant and slid over the end of the handle, as shown at 830. When the disinfectant dries up or becomes depleted, more of the liquid can be sprayed on the cover while it is in place on the handle.

The material for use in the foregoing embodiments is a flexible, absorbent substance that is not damaged by extended exposure to the disinfectant or antiseptic solution in use. A medium or high-density open-cell foam, such as a polypropylene foam or a melamine foam, is preferred. However, other types of polymer foam, as well as flexible, absorbent materials such as cotton or cellulose, may be used as well.

FIG. 5 shows how a flat sheet of the flexible, absorbent material 500 can be processed to produce an embodiment similar to the ones shown in FIGS. 1 and 2. The flat sheet 500, having a length 510 and a width 530, is curled into a tube by bringing side edges 513 and 516 up and towards each other, as shown at 550. To complete the embodiment, edges 513 and 516 are brought fully together and secured, either in an overlap joint (FIG. 1) or a butt joint (FIG. 2). An adhesive, such as cyanoacrylate or another acrylate polymer, may be used to bond the edges together permanently.

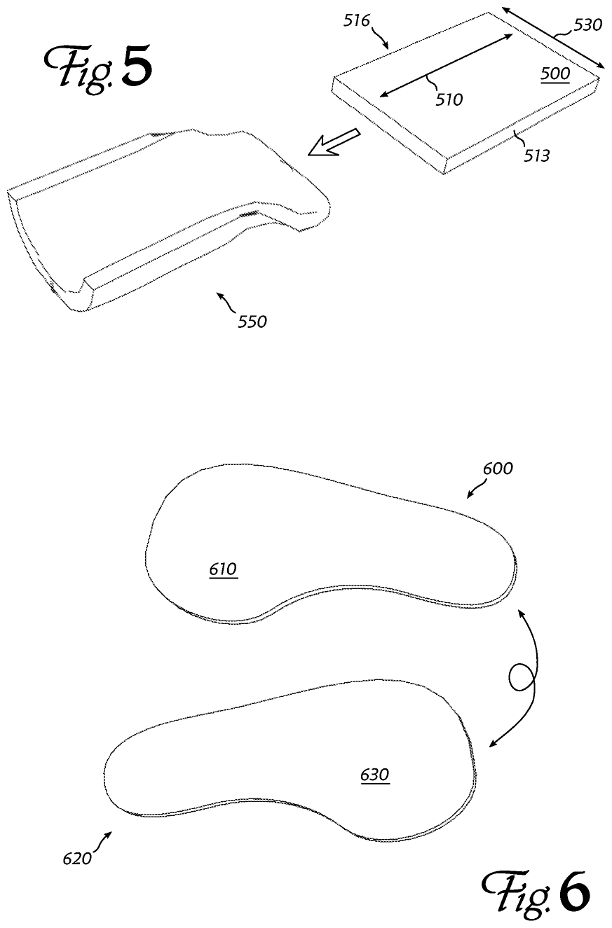

FIG. 6 shows another embodiment of the invention. Instead of the tubular forms shown earlier, this embodiment is provided as a flat, shaped portion 600 of the flexible absorbent material, with an adhesive coating over some or all of a reverse surface (630). The adhesive surface is used to secure the embodiment to a lever or handle that would be challenging or impossible to fit with a tubular embodiment. Once secured, the exposed surface of the embodiment (610) may be soaked with the antiseptic or disinfectant solution to help prevent transfer of infectious agents from person to person via the covered lever or handle.

FIG. 7 shows a kit for protecting an assortment of high-touch surfaces over a period of time. The kit 700 comprises a container of a liquid antiseptic or disinfectant 710. The liquid may be an alcohol solution, for example, comprising at least 45% alcohol by volume (and preferably at least 70% by volume). The container is preferably configured as an atomizer or spray bottle, which facilitates re-wetting the absorbent, disinfecting material of handle covers. Further, a kit contains a number of handle covers 720, 730. A variety of sizes and shapes may be provided, with multiple instances of each, to protect many different surfaces and control handles. Instructions for installing or adhering the handle covers to various surfaces may be included. The instructions should direct the user to apply (or to re-apply) the liquid antiseptic to the flexible absorbent surfaces periodically, and to replace the handle covers when they become worn or soiled.

The applications of the present invention have been described largely by reference to specific examples and in terms of particular allocations of functionality to certain hardware and/or software components. However, those of skill in the art will recognize that infection control via disinfecting and sanitizing high-touch surfaces can also be produced by equipment and supplies that organize the functions of embodiments of this invention differently than herein described. Such variations and implementations are understood to be captured according to the following claims.

I claim:

1. A handle cover comprising:
an absorbent tubular structure having an inner diameter, a length and a thickness,
said absorbent tubular structure positioned to cover a surface of a manual control, and
said absorbent tubular structure soaked with a liquid having antiseptic properties.

2. The handle cover of claim 1 wherein the absorbent tubular structure is formed from an open-cell foam.

3. The handle cover of claim 2 wherein the open-cell foam is melamine foam.

4. The handle cover of claim 1 wherein the absorbent tubular structure is formed from a length of sheet material curled into a tube, wherein opposite edges of the sheet material are joined together in an overlap joint.

5. The handle cover of claim 1 wherein the absorbent tubular structure is formed from a length of sheet material curled into a tube, wherein opposite edges of the sheet material are joined together in a butt joint.

6. A handle cover comprising:
a shaped portion of a flexible, absorbent sheet material having one exposed surface and an opposing adhesive-covered surface.

7. The handle cover of claim 6 wherein the absorbent sheet material is an open-cell foam.

8. The handle cover of claim 7 wherein the open cell foam is a melamine foam.

9. A handle sanitation kit comprising:
a container of a liquid antiseptic solution; and
a plurality of absorbent tubular handle covers.

10. The handle sanitation kit of claim 9 wherein the liquid antiseptic solution is an ethanol solution.

11. The handle sanitation kit of claim 10 wherein the ethanol solution is at least 45% ethanol.

12. The handle sanitation kit of claim 10 wherein the ethanol solution is at least 70% ethanol.

13. The handle sanitation kit of claim 9 wherein the liquid antiseptic solution comprises acetic acid.

14. The handle sanitation kit of claim 9 wherein the liquid antiseptic solution comprises tea tree oil.

15. The handle sanitation kit of claim 9 wherein the container of liquid antiseptic solution is an atomizer.

16. The handle sanitation kit of claim 9 wherein the absorbent tubular handle covers are formed from an open-cell foam.

17. The handle sanitation kit of claim 16 wherein the open-cell foam is melamine foam.

18. The handle sanitation kit of claim 16 wherein the absorbent tubular handle covers are formed as a sheet of open-cell foam rolled into a cylinder with adjacent edges joined in a butt joint.

19. The handle sanitation kit of claim 16 wherein the absorbent tubular handle covers are formed as a sheet of open-cell foam rolled into a cylinder with adjacent edges joined in an overlap joint.

20. The handle sanitation kit of claim 9, further comprising:
printed instructions to spray the liquid antiseptic material on an absorbent tubular handle cover periodically.
